(19) United States
(12) Patent Application Publication
(10) Pub. No.: US 2013/0124676 A1
(43) Pub. Date: May 16, 2013

(54) CONTENT DISTRIBUTION APPARATUS AND METHOD

(71) Applicant: Toshiba Tec Kabushiki Kaisha, Tokyo (JP)

(72) Inventor: Katsuhito Mochizuki, Shizuoka-ken (JP)

(73) Assignee: TOSHIBA TEC KABUSHIKI KAISHA, Tokyo (JP)

(21) Appl. No.: 13/664,706

(22) Filed: Oct. 31, 2012

(30) Foreign Application Priority Data
Nov. 14, 2011 (JP) 2011-248924

(51) Int. Cl. G06F 15/16

(52) U.S. Cl. 709/217

(57) ABSTRACT

According to one embodiment, a content distribution apparatus comprises a first distribution unit, a setting unit, an acceptance unit and a second distribution unit. The first distribution unit distributes an object content continuously regenerated according to a preset regeneration order. The setting unit sets a linked destination content linked to the object content for each object content. The acceptance unit accepts the regeneration request of the linked destination content during a period when the object content is regenerated. The second distribution unit distributes the linked destination content set to be a regenerating object content when the regeneration request is accepted.

### CROSS-REFERENCE TO RELATED APPLICATION

This application is based upon and claims the benefit of priority from Japanese Patent Application No. 2011-248924, filed Nov. 14, 2011, the entire contents of which are incorporated herein by reference.

### FIELD

Embodiments described herein relate to a content distribution apparatus and a method.

### BACKGROUND

Equipment linked from one website content to other contents has already existed in a display in which the website content is distributed to regenerate the website content regardless of digital signage.

### BRIEF DESCRIPTION OF THE DRAWINGS

FIG. 1 is a block diagram showing sketchy compositions of an information processing system according to the present embodiment relates;

FIG. 2 is a front view of an appearance of a digital signage terminal apparatus;

FIG. 3 is a block diagram showing sketchy compositions of the digital signage terminal apparatus;

FIG. 4 is a block diagram showing sketchy compositions of an information distribution server;

FIG. 5 is a drawing showing data compositions of a content information table;

FIG. 6 is a drawing showing data compositions of a linked destination content information table;

FIG. 7 is a block diagram showing function compositions of the information distribution server according to the present embodiment relates;

FIG. 8 is a drawing showing an example of a display picture displayed on a display unit of the information distribution server;

FIG. 9 is a drawing showing an example of the display picture displayed on the display unit of the information distribution server;

FIG. 10 is a drawing showing an example of a preview picture;

FIG. 11 is a drawing showing an example of the preview picture;

FIG. 12 is a flow chart showing a flow of the content distribution processing in the information distribution server; and

FIG. 13 is a drawing used for describing the migration of a picture displayed on a display unit of the digital signage terminal apparatus regenerating a content distributed from the information distribution server.

### DETAILED DESCRIPTION

According to one embodiment, a content distribution apparatus comprises a first distribution unit, a setting unit, an acceptance unit and a second distribution unit. The first distribution unit distributes an object content continuously regenerated according to a preset regeneration order. The setting unit sets a linked destination content linked to the object content for each object content. The acceptance unit accepts the regeneration request of the linked destination content during a period when the object content is generated. The second distribution unit distributes the linked destination content set to be a regenerating object content when the regeneration request is accepted.

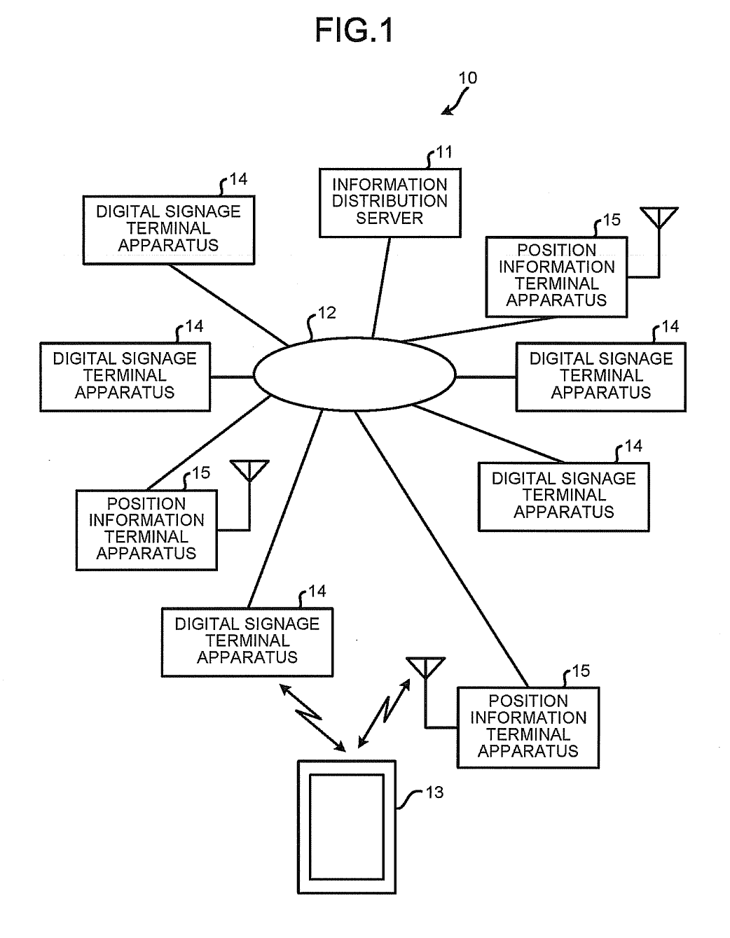

FIG. 1 is a block diagram showing sketchy compositions of an information processing system according to the present embodiment relates. In the following description, the condition that the information processing system according to the present embodiment relates is installed in a shopping mall is described.

The information processing system 10 according to the present embodiment comprises: an information distribution server 11 configured to distribute the content of information such as information about advertisement of a commodity or an event and the like, a plurality of digital signage terminal apparatuses 14 configured to display the content distributed from the information distribution server 11 via a communication network 12 such as an LAN (Local Area Network) and the like in a structure, and moreover, to distribute information relevant with the information of the advertisement or the event and the like to a portable information terminal apparatus 13 carried by a customer in the shopping mall, and a plurality of position information terminal apparatuses 15 configured to notify information determination information used for determining the position of the portable information terminal apparatus 13 to the portable information terminal apparatus 13 by wireless communication.

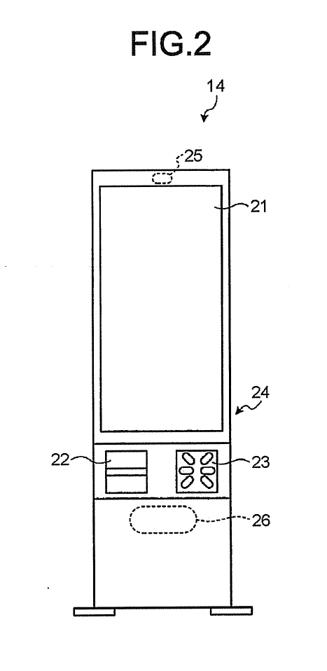

FIG. 2 is a front view of an appearance of the digital signage terminal apparatus. The digital signage terminal apparatus 14 comprises: a display unit 21 formed to be a liquid crystal display or a plasma display, a printer unit 22 printing and issuing various tickets, coupons and the like, a short-distance wireless communication section 23 carrying out communication with the portable information terminal apparatus 13 by short-distance wireless communication whose communication distance is about 1 inch to 10 inches, and a shell section 24 supporting the display unit 21, the printer unit 22 and the short-distance wireless communication section 23.

A camera unit 25 used for photographing a user to carry out image recognition, determine the age group of the user, control the kind of the distributed information, and the like, and a loudspeaker unit 26 carrying out various sounds output such as a BGM or an advertising sound and the like are internally placed on the upper part of the shell section 24. In addition, the image recognition processing and the like also can be carried out without using the digital signage terminal apparatus 14 and may be carried out by an upstream server such as the information distribution server 11 and the like.

As the printer unit 22, for instance, a printer apparatus using roll paper as a recording medium and adopting a heat-sensitive recording way is used and comprises a cropping mechanism automatically cropping the roll paper as required.

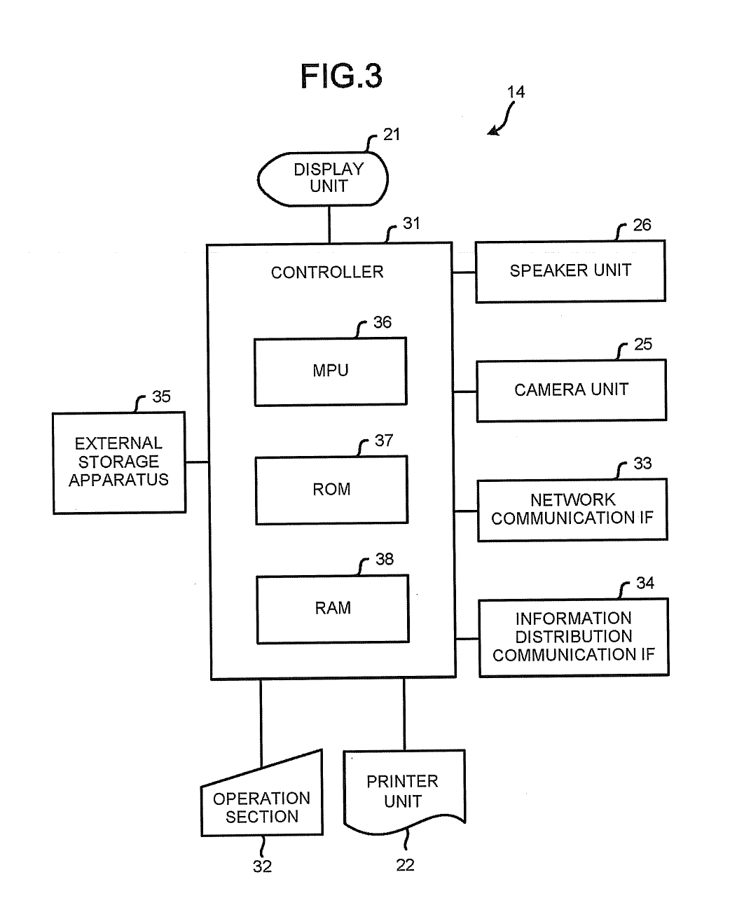

FIG. 3 is a block diagram showing sketchy compositions of the digital signage terminal apparatus. Besides the display unit 21, the printer unit 22, the camera unit 25 and the loudspeaker unit 26, the digital signage terminal apparatus 14 further comprises: a controller 31 controlling the whole digital signage terminal apparatuses 14, an operation section 32 used for carrying out various operations by an operator or the user, a network communication interface (IF) 33 used for carrying out the communication with the information distribution server 11 via the communication network 12, an information distribution communication interface (IF) 34 including the short-distance wireless communication section 23 and used for distributing the information associated with the advertisement or the event and the like to the portable information terminal apparatus 13, and an external storage apparatus 35 storing various data.

Herein, the controller 31 comprises: an MPU (Micro Processing Unit) 36 controlling all the controllers 31, an ROM (Read Only Memory) 37 storing a control program and the like used for enabling the MPU 36 to operate, and an RAM (Random Access Memory) 38 temporarily storing the various data. Moreover, the controller 31 regenerates the content distributed from the information distribution server 11 via the communication network 12 by executing the control program stored in the ROM 37 for the MPU 36, so as to display the regenerated content on the display unit 21. In addition, the operation section 32 is formed by various switches, buttons and the like, or also can be integrally formed with the display unit 21 as a touch panel.

When the information associated with the advertisement or the event and the like is distributed to the portable information terminal apparatus 13, besides that the communication is carried out via the information distribution communication interface (IF) 34, the distribution also can be formed to be carried out by displaying, for instance, a two-dimensional barcode on the display picture of the display unit 21 and photographing the two-dimensional barcode by using the camera unit 25 of the portable information terminal apparatus 13 to carry out decoding.

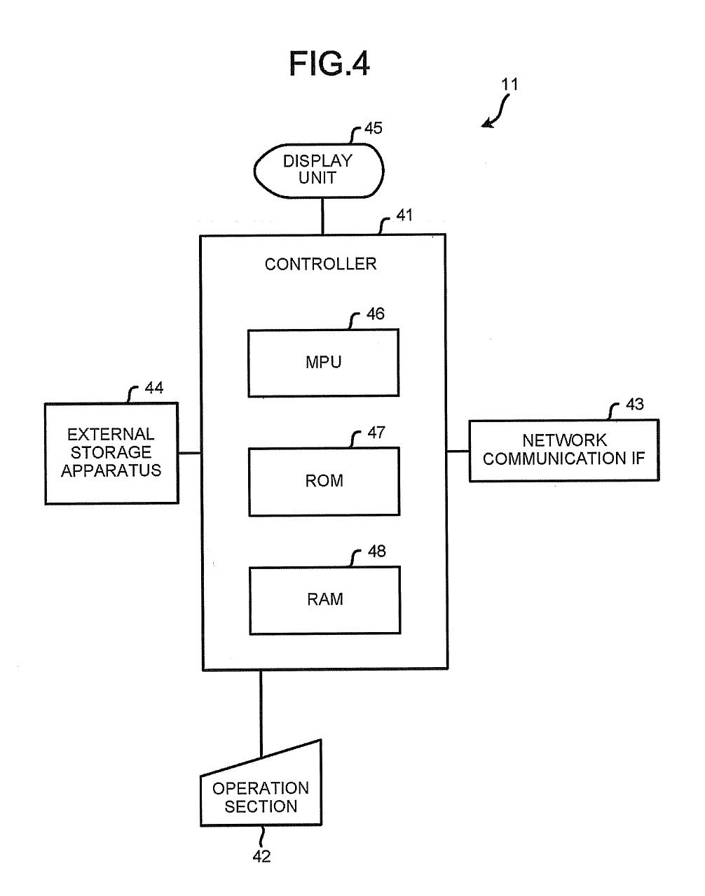

FIG. 4 is a block diagram showing sketchy compositions of the information distribution server. The information distribution server 11 comprises: a controller 41 controlling the whole information distribution servers 11, an operation section 42 comprising a keyboard or a mouse and the like used for carrying out the various operations by the operator, a network communication interface (IF) 43 used for carrying out the communication with the digital signage terminal apparatus 14 via the communication network 12, an external storage apparatus 44 storing the various data, and a display unit 45 formed to be the liquid crystal display.

Herein, the controller 41 comprises an MPU 46 controlling the whole controllers 41, an ROM 47 storing the control program and the like used for enabling the MPU 46 to operate, and an RAM 48 temporarily storing the various data.

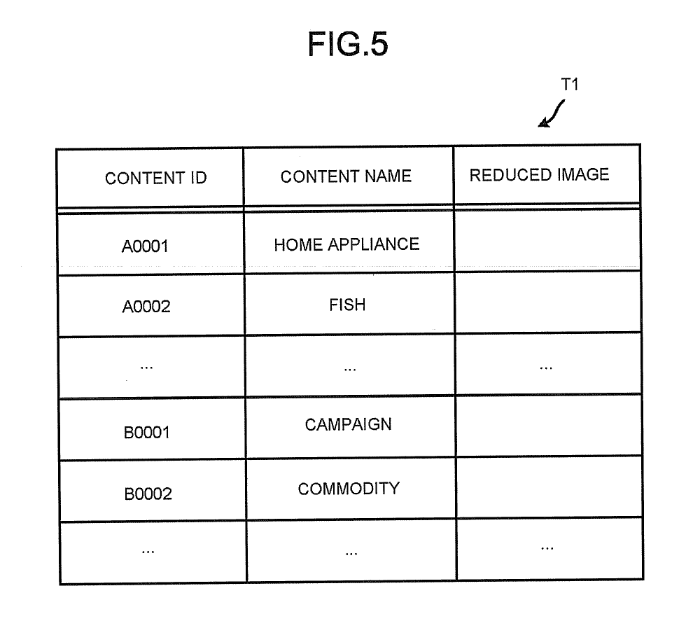

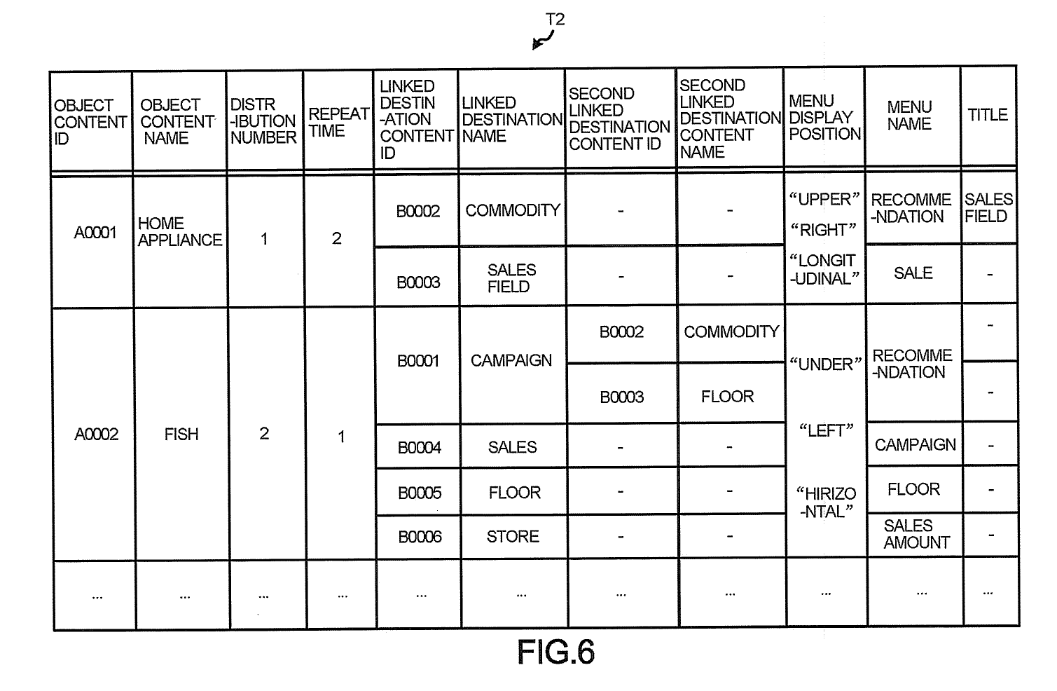

The external storage apparatus 44 stores the content of the information of the advertisement or the event and the like, a content information table T1 (refer to FIG. 5) and a linked destination content information table T2 (refer to FIG. 6). In addition, in the present embodiment, the content is stored in the external storage apparatus 44 of the information distribution server 11, but is not limited to that, for instance, the content also can be stored in a storage apparatus connected with the information distribution server 11 via the communication network 12.

FIG. 5 is a drawing showing data compositions of the content information table. As shown in FIG. 5, as recognition information recognizing the content stored in the external storage apparatus 44, the content information table T1 correspondingly stores a content ID, the content name of the content recognized by the content ID, and the reduced image of an image regenerating the content recognized by the content ID.

FIG. 6 is a drawing showing data compositions of the linked destination content information table. As shown in FIG. 6, the linked destination content information table T2 correspondingly stores an object content ID, an object content name, a distribution number, a repeat time, a linked destination content ID, a linked destination content name, a second linked destination content ID, a second linked destination content name, a menu display position, a menu name and a title name.

The object content ID is a content ID of the content (hereinafter, called as object content) which is in the content stored in the external storage apparatus 44 and continuously regenerated by using the digital signage terminal apparatus 14. The object content name is the content name of the object content recognized by the object content ID. The distribution number represents a order of distributing the object content to the digital signage terminal apparatus 14. In the present embodiment, the digital signage terminal apparatus 14 regenerates the object content according to the order distributed from the information distribution server 11. Therefore, in the present embodiment, the distribution number represents the regeneration order of the object content in the condition that a plurality of object contents are continuously regenerated in the digital signage terminal apparatus 14. The repeat time is the time of repeating the regeneration of the object content in the digital signage terminal apparatus 14.

The linked destination content ID is a content ID recognizing the content (hereinafter, called as linked destination content) which is in the content stored in the external storage apparatus 44 and linked to the object content. The linked destination content name is the content name of the linked destination content recognized by the linked destination content ID. The second linked destination content ID is the content ID recognizing the content (hereinafter, called as second linked destination content) which is in the content stored in the external storage apparatus 44 and linked to the linked destination content. The second linked destination content name is the content name of the second linked destination content recognized by the second linked destination content ID.

The menu display position is a position displaying a menu button (operation image) used for carrying out the regeneration request of the linked destination content linked to the regenerating object content in the regenerating object content. The menu name is the name of the menu button displayed on the menu button. The title is the name of the linked destination content subjected to the regeneration request by the menu button.

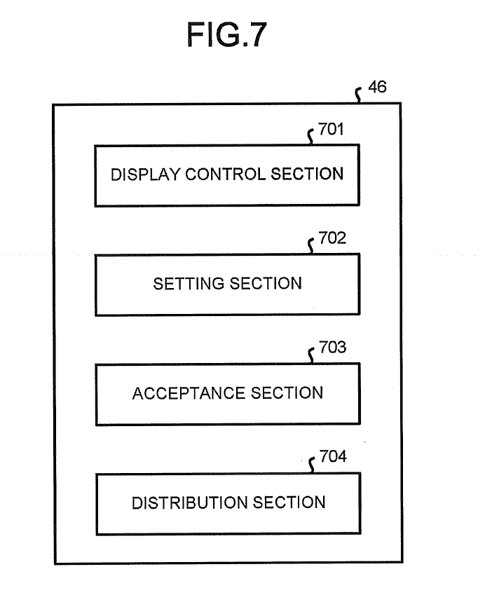

The special functions of the information distribution server 11 according to the present embodiment relates are described. FIG. 7 is a block diagram showing function compositions of the information distribution server according to the present embodiment relates. The MPU 46, as shown in FIG. 7, exerts functions as a display control section 701, a setting section 702, an acceptance section 703 and a distribution section 704 by operating according to the control program stored in the ROM 47.

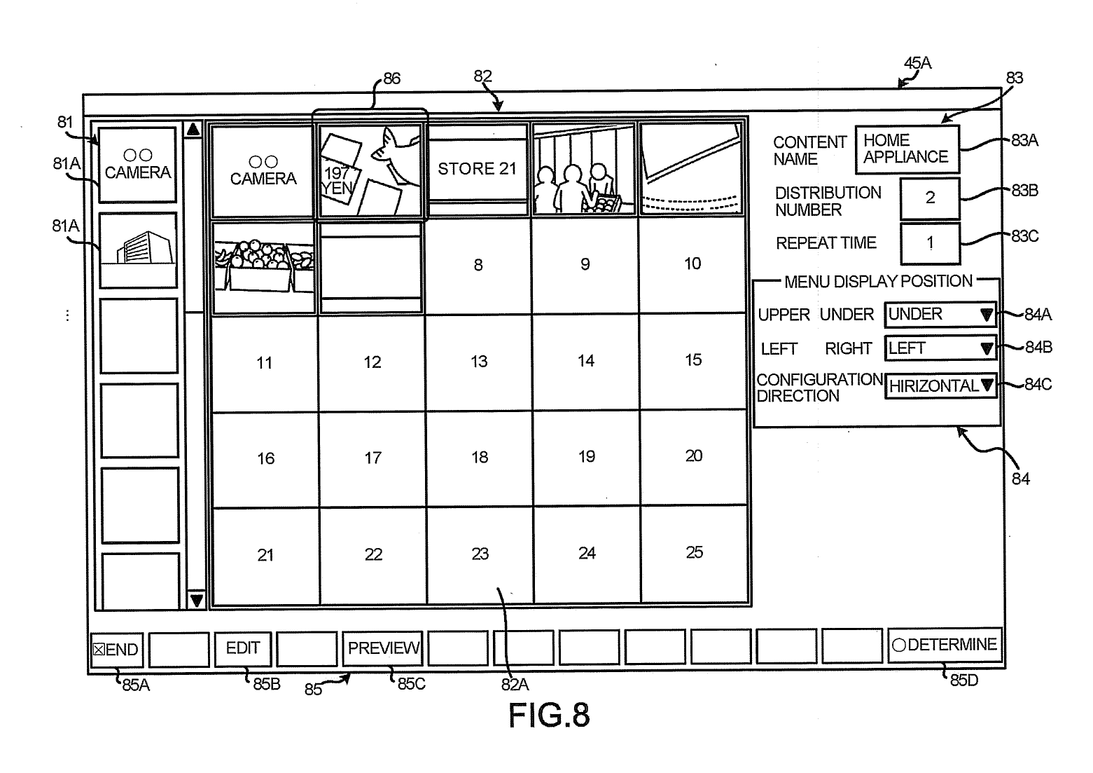

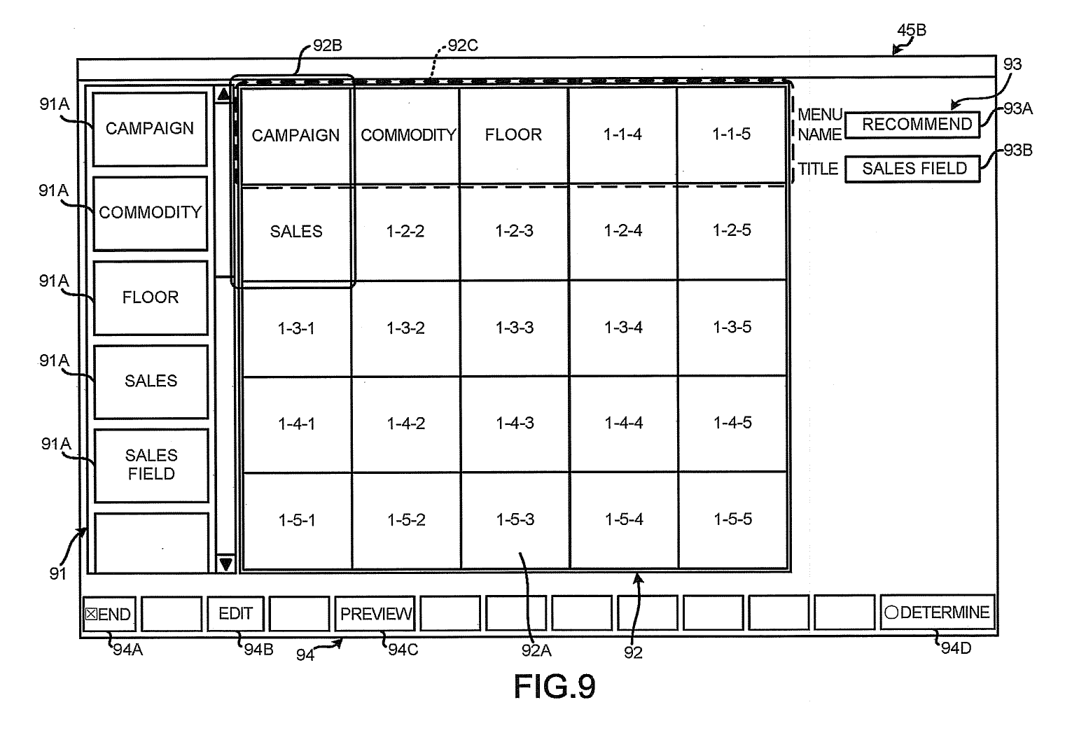

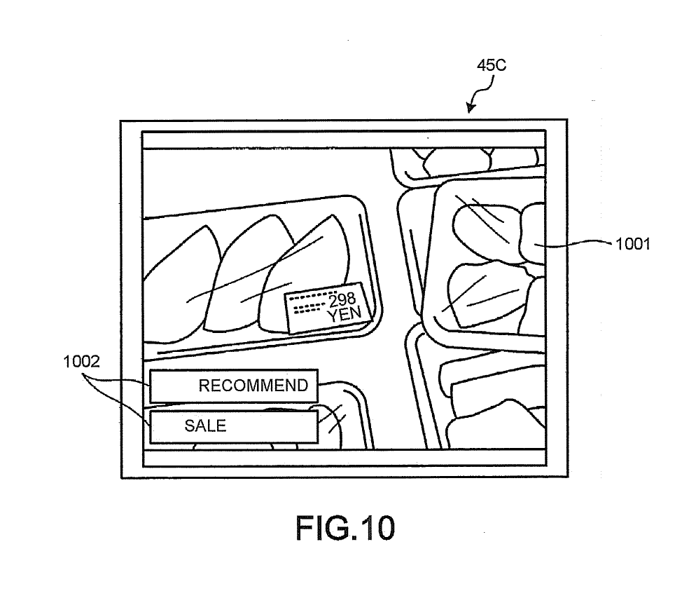

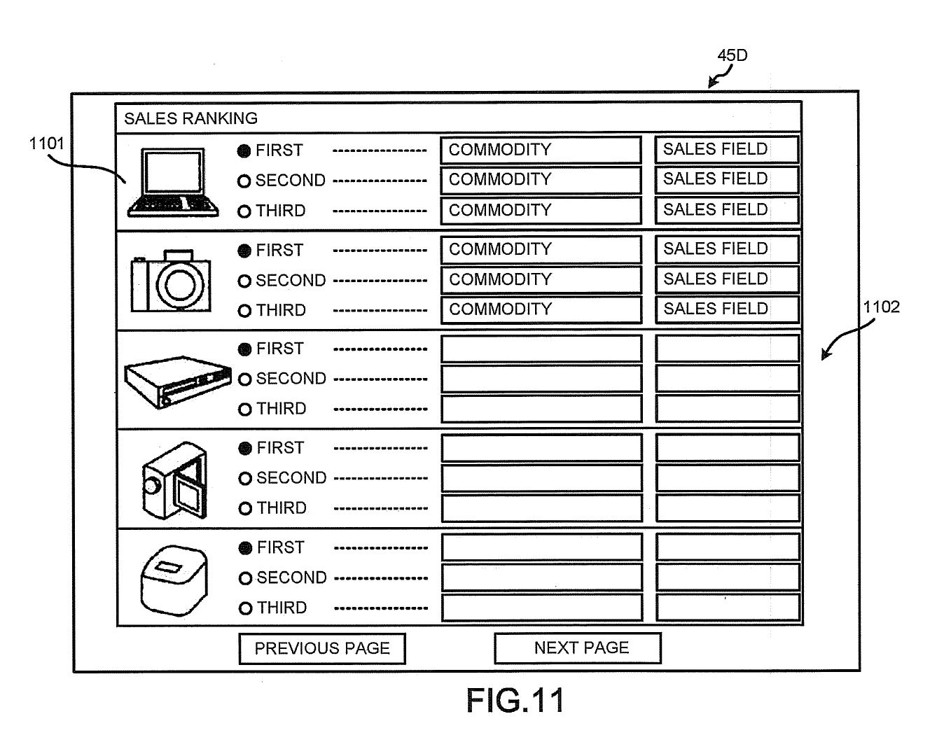

The display control section 701 displays display pictures 45A and 45B (refer to FIG. 8 and FIG. 9) and preview pictures 45C and 45D (refer to FIG. 10 and FIG. 11) on the display unit 45. In addition, the display control section 701 overlaps the menu button on the image after the object content is regenerated to carryout display when the object content is regenerated on the digital signage terminal apparatus 14. In addition, in the present embodiment, the display control section 701 (addition section) adds the information (for instance, the menu display position and the content and the like of an image text used for displaying the menu button of the linked destination content set by the object content) used for displaying the menu button to the object content distributed to the digital signage terminal apparatus 14 to carry out distribution. Therefore, the controller 31 of the digital signage terminal apparatus 14 displays the menu button in an overlapping way for the object content regenerated in the digital signage terminal apparatus 14.

FIG. 8 and FIG. 9 are drawings showing an example of the display picture displayed on the display unit of the information distribution server. After the operation section 42 operates and the digital signage terminal apparatus 14 requests the determination of the regenerated object content, the display control section 701 displays the display picture 45A (refer to FIG. 7) on the display unit 45.

The display picture 45A generally comprises a summary display region 81 and an editing region 82. The summary display region 81 is a region displaying the summary of the content stored in the external storage apparatus 44. In the present embodiment, the thumbnail image 81A stored in the content information table T1 is displayed in the summary display region 81. In addition, in the present embodiment, the thumbnail image 81A stored in the content information table T1 is displayed in the summary display region 81, but is not limited to that, and if the displayed content of the summary of the information is relevant with the content stored in the external storage apparatus 44, it is also displayed. For instance, the content name and the like stored in the content information table T1 also can be displayed in the summary display region 81.

The editing region 82 is a region used for setting the object content regenerated in the digital signage terminal apparatus 14 and the regeneration order of the object content. In the present embodiment, the editing region 82 comprises a plurality of regions 82A displaying a numeral representing the regeneration order of the object content. The operator of the information distribution server 11 carries out the operation on the operation section 42, drags the thumbnail image 81A displayed on the summary display region 81 and drops the thumbnail image 81A in the region 82A displaying the numeral representing an expected regeneration order in the regions 82A of the editing region 82, so as to set the object content and the regeneration order of the object content.

The display picture 45A comprises a regeneration condition setting region 83, a menu display position setting region 84 and a function button region 85. The regeneration condition setting region 83 is a region used for setting a regeneration condition when the set object content is regenerated. In the present embodiment, the regeneration condition setting region 83 comprises: a content name setting bar 83A used for setting the content name of the set object content, a distribution number setting bar 83B used for setting the distribution number representing the order of distributing the set object content to the digital signage terminal apparatus 14, a repeat time setting bar 83C used for setting the repeat time of repeatedly regenerating the set object content, and the like.

In the present embodiment, as the digital signage terminal apparatus 14 regenerates the object content according to the order distributed from the information distribution server 11, the distribution number set in the distribution number setting bar 83B becomes the regeneration order of regenerating the object content when the digital signage terminal apparatus 14 regenerates the object content.

The menu display position setting region 84 is a region used for setting the menu display position of the menu button, and the menu button is the operation image used for carrying out the regeneration request of the linked destination content linked to the set object content. In the present embodiment, the menu display position setting region 84 comprises: a button 84A used for setting the position (“upper” or “under”) of the vertical direction of the menu button in the set object content, a button 84B used for setting the position (“left” or “right”) of the left-right direction of the menu button in the set object content, a button 84C used for setting a configuration direction (“longitudinal” or “horizontal”) arranging a plurality of menu buttons when the plurality of menu buttons are displayed, and the like.

The function button region 85 comprises: a termination button 85A used for requesting the setting termination of the object content, a link button 85B used for requesting the setting of the linked destination content linked to the set object content, a preview button 85C used for requesting the display of the preview image of the set object content, a determination button 85D used for determining various settings in the display picture 45A, and the like.

When the operator carries out the operation on the operation section 42 and move a cursor 86 in the thumbnail image 81A of the object content of the set linked destination content in the set object content, and moreover, presses down the link button 85B of the display picture 45A, the display control section 701 displays the display picture 45B (refer to FIG. 9) on the display unit 45.

The display picture 45B generally comprises a summary display region 91 and an editing region 92. The summary display region 91 is a region displaying the summary of the content which is stored in the content in the external storage apparatus 44 and can be set to be the linked destination content. In the present embodiment, a content name 91A stored in the content information table T1 is displayed in the summary display region 91. In addition, in the present embodiment, the name content 91A stored in the content information table T1 is displayed in the summary display region 91, but is not limited to that, and if the displayed content of the summary of the information is relevant with the content stored in the external storage apparatus 44, it is also displayed. For instance, the thumbnail image and the like stored in the content information table T1 also can be displayed in the summary display region 91.

The editing region 92 is a region used for setting the linked destination content linked to the object content and the second linked destination content linked to the linked destination content. In the present embodiment, the editing region 92 comprises a plurality of regions 92A displaying an intrinsic recognition number. The operator of the information distribution server 11 carries out the operation on the operation section 42, and drags the content name 91A displayed in the summary display region 91, and drops the content name 91A to a row 92B at a left end in the region 92A of the editing region 92, so as to set the linked destination content linked to the object content. In addition, the operator of the information distribution server 11 further can set a plurality of linked destination contents for one object content by dragging a plurality of content names 91A to the row 92B at the left end in the region 92A. In FIG. 9, as the content name 91A “campaign” and “sales actual performance” is dragged to the row 92B at the left end in the region 92A, the content that the content name 91A “campaign” and “sales actual performance” represents is set to be the linked destination content.

The operator of the information distribution server 11 carries out the operation on the operation section 42, drags the content name 91A displayed in the summary display region 91, and drags the dragged content name 91A to a line 92C in which the content name 91A in the row 92B at the left end in the region 92A of the editing region 82 has been dragged, so as to set the second linked destination content linked to the linked destination content. In FIG. 9, as the content name 91A “commodity” and “floor” is dragged to the line 92C in which the content name 91A “campaign” in the row 92B at the left end has been dragged, the content that the content name 91A “commodity” and “floor” represents is set to be the second linked destination content.

The display picture 45B comprises a menu name/title setting region 93 and a function button region 94. The menu name/title setting region 93 comprises a menu name setting bar 93A used for setting the menu name which is the name of the menu button used for carrying out regeneration request of the set linked destination content and a title setting bar 93B used for setting the title which is the name of the linked destination content after being carried out the regeneration request according to the menu button.

The function button region 94 comprises: a termination button 94A used for requesting the setting termination of the linked destination content (or the second linked destination content), an editing button 94B used for requesting the editing of the set linked destination content (or the second linked destination content), a preview button 94C used for requesting the display of the preview image of the set linked destination content, and a determination button 94D used for determining various settings in the display picture 45B.

FIG. 10 and FIG. 11 are drawings showing an example of the preview picture. During the period that when the display picture 45A is displayed, if the operator carries out the operation on the operation section 42 and move the cursor 86 in the thumbnail image 81A of the set object content, and moreover, presses down the preview button 85C of the display picture 45A, the display control section 701 displays the preview picture 45C (refer to FIG. 10) on the display unit 45.

When the preview button 85C is pressed down, the display control section 701 determines the content ID set corresponding to the thumbnail image 81A moved by the cursor 86 in the content information table T1. Afterwards, the display control section 701 reads out the content which is recognized by the determined content ID from the external storage apparatus 44. Next, the display control section 701 displays the preview picture 45C including a content region 1001 regenerating the read-out content (object content).

In addition, the display control section 701 acquires the menu display position set in the menu display position setting region 84 and the menu name set in the menu name/title setting region 93. Afterwards, the display control section 701 displays a menu button 1002 displaying the acquired menu name in the content region 1001 in the overlapping way according to the acquired menu display position.

When the plurality of set linked destination contents exist in the editing region 92, the display control section 701 acquires a plurality of menu names set for each of the plurality of linked destination contents in the menu name/title setting region 93. Afterwards, the display control section 701 displays the menu button 1002 displaying any one of the plurality of acquired menu names in the content region 1001 in the overlapping way. That is, the display control section 701 displays the menu button 1002 of the quantity of the set linked destination content towards the object content.

For instance, when the acquired menu display position is “under”, “left” and “horizontal”, and moreover, the read-out menu name is “recommendation” and “sale”, the display control section 701 horizontally displays the menu button 1002 displaying the “recommendation” and the menu button 1002 displaying the “sale” at the left under part of the content region 1001 side by side.

When the operator carries out the operation on the operation section 42 and move the cursor (not shown) in the content name 91A of the set linked destination content, and moreover, presses down the preview button 94C of the display picture 45B, the display control section 701 displays the preview picture 45D (refer to FIG. 11) on the display unit 45.

When the preview button 94C is pressed down, the display control section 701 determines the content ID set corresponding to the content name 91A which is moved with the cursor (not shown) in the content information table T1. Afterwards, the display control section 701 reads out the content which is recognized by the determined content ID from the external storage apparatus 44. Next, the display control section 701 displays the preview picture 45D including a content region 1101 regenerating the read-out content (linked destination content).

Moreover, in the condition that other content name 91A exists in the line of the content name 91A in which the cursor (not shown) is moved in the editing region 92, that is, in the condition that the second linked destination content is set, the display control section 701 displays a button (operation image) 1102 used for carrying out the regeneration request of the second linked destination content in the content region 1101 in the overlapping way.

Referring back to FIG. 7, when the determination button 85D of the display picture 45A displayed by the display control section 701 is pressed down, the setting section 702 acquires various settings (the object content, the regeneration order of the object content, the content name of the object content, the distribution number of the object content, the repeat time of the object content, the regeneration condition, the menu display position and the like) set in the display picture 45A.

Besides, when the determination button 94D of the display picture 45B displayed by the display control section 701 is pressed down, the setting section 702 acquires various settings (the linked destination content, the second linked destination content, the title name, the title and the like) set in the display picture 45B.

Afterwards, the setting section 702 stores the acquired various settings (the regeneration order, the content name, the distribution number, the repeat time, the regeneration condition, the menu display position, the linked destination content ID which is the content ID of the linked destination content, the second linked destination content ID which is the content ID of the second linked destination content, the menu name, the title and the like) corresponding to the object content ID in the linked destination content information table T2 after corresponding that the object content ID is the content ID of the object content included in the acquired various settings. Therefore, the setting section 702 is in the state that the various settings in the display pictures 45A and 45B are set.

When the object content is regenerated in the digital signage terminal apparatus 14, the acceptance section 703 accepts the regeneration request of the linked destination content carried out by pressing down the menu button 1002 displayed on the display unit 21 of the digital signage terminal apparatus 14 by the display control section 701.

When the linked destination content is regenerated in the digital signage terminal apparatus 14, the acceptance section 703 accepts the regeneration request of the second linked destination content carried out by pressing down the menu button 1102 (refer to FIG. 11) displayed on the display unit 21 of the digital signage terminal apparatus 14 by the display control section 701.

When the distribution of the object content is requested from the digital signage terminal apparatus 14, the distribution section 704 (the first distribution section) reads out the object content recognized by the object content ID stored in the linked destination content information table T2 from the external storage apparatus 44. Afterwards, the distribution section 704 distributes the read-out object content to the digital signage terminal apparatus 14 according to the distribution number stored corresponding to the object content ID of the read-out object content in the linked destination content information table T2. In addition, in the condition the repeat time set corresponding to the object content ID of the read-out object content is above “2”, the distribution section 704 carries out the distribution of the object content of a next distribution number after carrying out the repeat time quantity of the distribution on the read-out object content.

When the acceptance section 703 accepts the regeneration request of the linked destination content, the distribution section 704 (the second distribution section) distributes the linked destination content set to be the regenerating object content when the acceptance section 703 accepts the regeneration request. In the present embodiment, when the acceptance section 703 accepts the regeneration request of the linked destination content, the distribution section 704 reads out the linked destination content ID set corresponding to the object content ID distributed to the digital signage terminal apparatus 14 from the linked destination content information table T2. Afterwards, the distribution section 704 reads out the content which is recognized by the read-out linked destination content ID from the external storage apparatus 44. Next, the distribution section 704 distributes the read-out content which as linked destination content set by the regenerating object content to the digital signage terminal apparatus 14.

When the acceptance section 703 accepts the regeneration request of the second linked destination content, the distribution section 704 (the second distribution section) distributes the second linked destination content set to be a regenerating linked destination content when the regeneration request is accepted. In the present embodiment, when the acceptance section 703 accepts the regeneration request of the second linked destination content, the distribution section 704 reads out the second linked destination content ID set corresponding to the linked destination content ID distributed to the digital signage terminal apparatus 14 from the linked destination content information table T2. Afterwards, the distribution section 704 reads out the content which is recognized by the read-out second linked destination content ID from the external storage apparatus 44. Next, the distribution section 704 distributes the read-out content which as the second linked destination set by the regenerating linked content to the digital signage terminal apparatus 14.

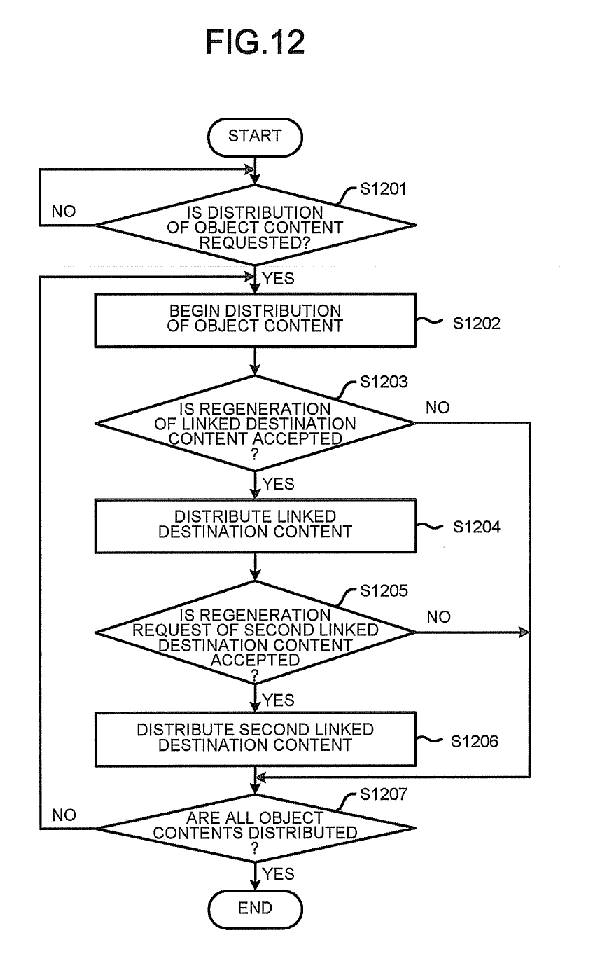

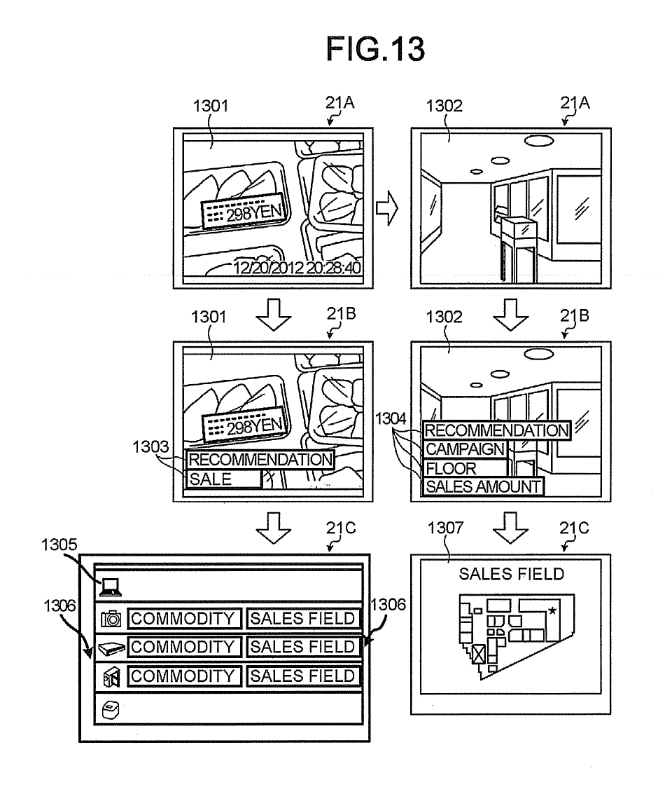

The distribution processing of the content in the information distribution server 11 is described in detail by using FIG. 12 and FIG. 13. FIG. 12 is a flow chart showing a flow of the distribution processing of the content in the information distribution server. FIG. 13 is a drawing used for describing the migration of a picture displayed on the display unit of the digital signage terminal apparatus regenerating the content distributed from the information distributed server.

The distribution section 704 requests the distribution of the object content from the digital signage terminal apparatus 14 after a power supply of the digital signage terminal apparatus 14 is turned on (Act S1201: No) . When the distribution of the object content is requested from the digital signage terminal apparatus 14 (Act S1201: Yes), the distribution section 704 reads out the object content recognized by the object content ID stored in the linked destination content information table T2 from the external storage apparatus 44. Afterwards, the distribution section 704 begins the distribution of the read-out object content to the digital signage terminal apparatus 14 according to the distribution number stored corresponding to the object content ID of the read-out object content in the linked destination content information table T2 (Act S1202).

The controller 31 of the digital signage terminal apparatus receives the object content distributed from the distribution section 704 via the network communication IF 33. Afterwards, the controller 31 regenerates the received object content according to the order of receiving the object content and displays the image of the regenerated object content on the display unit 21. For instance, in the condition that the reception is carried out according to the order of the object content of the object content ID “A0001” and the object content of the object content ID “A0002”, the controller 31, as shown in FIG. 13, displays a display picture 21A including an image 1301 regenerating the object content of the object content ID “A0001” on the display unit 21. Afterwards, when the regeneration of the object content of the object content ID “A0001” is terminated, the controller 31 displays the display picture 21A including an image 1302 regenerating the object content of the object content ID “A0002” on the display unit 21.

During the period when the regeneration of the object content is carried out in the digital signage terminal apparatus 14, the acceptance section 703 waits the regeneration request of the linked destination content (Act S1203). In the present embodiment, during the period when the image regenerating the object content is displayed on the display unit 21 by the controller 31 of the digital signage terminal apparatus 14, the display control section 701 judges whether or not a touch operation is carried out on the operation section 32 (touch panel). Next, in the condition that the touch operation is judged to be carried out on the operation section 32, the display control section 701 acquires the menu display position and the menu name which are set corresponding to the object content ID of the object content distributed from the distribution section 704 in the linked destination content information table T2. Next, the display control section 701 carries out the distribution by adding the information used for displaying the menu button displaying the acquired menu name on the object content in the overlapping way to the object content, and overlaps the menu button on the image regenerating the object content to display the menu button on the display unit 21.

For instance, in the condition that the display picture 21A including the picture 1301 regenerating the object content of the object content ID “A0001” is displayed on the display unit 21, and moreover, the user of the digital signage terminal apparatus 14 carries out the touch operation on the operation section 32 (touch panel), the display control section 701 acquires the menu display position (“under”, “left”, “horizontal”) and the menu name (“recommendation”, “sale”) which are stored corresponding to the object content ID “A0001” in the linked destination content information table T2. Next, the display control section 701 displays a display picture 21B on the display unit 21 by distributing the information used for displaying the display picture 21B horizontally displaying a menu button 1303 displaying the menu name “recommendation” and the menu button 1303 displaying the acquired menu name “sale” at the left under part of the picture 1301 side by side to the digital signage terminal apparatus 14.

In the condition that the display picture 21A including the picture 1302 regenerating the object content of the object content ID “A0002” is displayed on the display unit 21, and moreover, the user of the digital signage terminal apparatus 14 carries out the touch operation on the operation section 32 (touch panel), the display control section 701 acquires the menu display position (“under”, “left”, “longitudinal”) and the menu name (“recommendation”, “campaign”, “floor”, “sales volume”) which are stored corresponding to the object content ID “A0002” in the linked destination content information table T2. Next, the display control section 701 displays the display picture 21B on the display unit 21 by distributing the information used for displaying the display picture 21B longitudinally displaying a menu button 1304 displaying the menu name “recommendation”, the menu button 1304 displaying the acquired menu name “campaign”, the menu button 1304 displaying the menu name “floor” and the menu button 1304 displaying the “sales volume” at the left under part of the image 1302 side by side to the digital signage terminal apparatus 14.

When the menu button displayed on the display unit 21 is pressed down, the acceptance section 703 accepts the regeneration request of the linked destination content (Act S1203: Yes). When the regeneration request of the linked destination content is accepted, the distribution section 704 acquires the linked destination content ID and the title which are stored corresponding to the menu name displayed on the pressed-down menu button in the linked destination content information table T2. Afterwards, the distribution section 704 reads out the content which is recognized by the acquired linked destination content ID from the external storage apparatus 44. Next, the distribution section 704 adds the acquired title to the read-out content as the linked destination content to distribute to the digital signage terminal apparatus 14 (Act S1204).

The controller 31 of the digital signage terminal apparatus 14 receives the linked destination content distributed from the distribution section 704 through the network communication IF 33. Afterwards, the controller 31 regenerates the received linked destination content and overlaps the title added to the received linked destination content on the image of the regenerated linked destination content to display on the display unit 21. For instance, in the condition that the linked destination content of the linked destination content ID “B0001” is received, the controller 31, as shown in FIG. 13, displays a display picture 21C including an image 1305 regenerating the linked destination content of the linked destination content ID “B0001” on the display unit 21. On the other hand, in the condition that the linked destination content of the linked destination content ID “B0002” is received, the controller 31, as shown in FIG. 13, displays the display picture 21C including an image 1307 regenerating the linked destination content of the linked destination content ID “B0002” and the acquired title “sale” on the display unit 21.

During the period when the regeneration of the linked destination content is carried out in the digital signage terminal apparatus 14, the acceptance section 703 waits the regeneration request of the second linked destination content (Act S1205). In the present embodiment, the display control section 701 judges whether or not the second linked destination content ID set corresponding to the linked destination content ID of the linked destination content regenerated in the digital signage terminal apparatus 14 exists in the linked destination content information table T2. Afterwards, in the condition that the second linked destination content ID set corresponding to the linked destination content ID exists, the display control section 701 displays the button on the display unit 21 by adding the information used for displaying the button used for carrying out the regeneration request of the seconded linked destination content on the image regenerating the linked destination content in the overlapping way to the linked destination content to distribute to the digital signage terminal apparatus 14.

For instance, in the condition that the second linked destination content ID “B0002” and “B0003” stored corresponding to the linked destination content ID “B0001” exists in the linked destination content information table R2, the display control section 701 displays the display picture 21C on the display unit 21 by adding the information used for displaying the display picture 21C to the linked destination content to distribute to the digital signage terminal apparatus 14, and a button 1306 used for carrying out the regeneration request of the second linked destination content is displayed on the display picture 21C.

When the button displayed on the display unit 21 is pressed down, the acceptance section 703 accepts the regeneration request of the second linked destination content (Act S1205: Yes). When the regeneration request of the second linked destination content is accepted, the distribution section 704 acquires the second linked destination content ID set corresponding to the linked destination content ID of the distributed linked destination content in the linked destination content information table T2. Afterwards, the distribution section 704 reads out the content which is recognized by the acquired second linked destination content ID from the external storage apparatus 44. Next, the distribution section 704 distributes the read-out content as the second linked destination content to the digital signage terminal apparatus 14 (Act S1206).

In the condition that the regeneration request of the linked destination content is not accepted (Act S1203: No), and moreover, if the regeneration request of the second linked destination content is not accepted (Act S1205: No), or after the second linked destination content is distributed to the digital signage terminal apparatus 14, the distribution section 704 judges whether or not all the object contents are distributed (Act S1207). In the condition that all the object contents are not distributed (Act S1207: No), the distribution section 704 returns to Act S1202 to carry out the distribution of the rest object content. On the other hand, in the condition that all the object contents are distributed (Act S1207: Yes), the information distribution server 11 terminates the distribution of the object content.

In this way, according to the information processing system 10 according to the present embodiment relates, by comprising the distribution section 704 distributing the object contents continuously regenerated according to a preset regeneration order, the setting section 702 setting the linked destination content linked to the object content for each object content, the acceptance section 703 accepting the regeneration request of the linked destination content during the period when the object content is regenerated, and the distribution section 704 distributing the linked destination content set to be the generating object content when the regeneration request is accepted, the linked destination content can be set for each object content, and therefore, the link to the content consistent with the generating object content can be realized.

A program executed by the information distribution server 11 of the present embodiment is provided by being recorded in a computer-readable recording medium such as a CD-ROM, a floppy drive (FD), a CD-R, a DVD (Digital Versatile Disk) and the like by using a file in an installable form or an executable form.

The program executed by the information distribution server 11 of the present embodiment also can be provided by being stored in a computer connected with a network such as the Internet and the like and being downloaded through the network. In addition, the program executed by the information distribution server 11 of the present embodiment also can be provided or allocated through the network such as the Internet and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A content distribution apparatus, comprising:
a first distribution unit configured to distribute an object content continuously regenerated according to a preset regeneration order;
a setting unit configured to set a linked destination content linked to the object content for each object content;
an acceptance unit configured to accept the regeneration request of the linked destination content during a period when the object content is regenerated; and
a second distribution unit configured to distribute the linked destination content set to be a regenerating object content when the regeneration request is accepted.

2. The content distribution apparatus according to claim 1, further comprising:
an addition unit configured to add the information used for displaying an operation image used for carrying out the regeneration request to the object content and distribute the object content which is added the information, wherein
the acceptance unit accepts the regeneration request carried out by the operation image.

3. The content distribution apparatus according to claim 2, wherein
the setting unit sets the display position of the operation image relative to the object content for each object content; and
the addition unit adds the information including the display position set to be the object content to the object content and distribute the object content which is added the information.

4. The content distribution apparatus according to claim 2, wherein
the setting unit sets a plurality of linked destination contents to be the object contents; and
the addition unit adds the information used for displaying as many the operation images as the linked destination contents set by the setting unit to the object content and distribute the object content which is added the information

5. The content distribution apparatus according to claims 1, wherein
the setting unit sets a second linked destination content linked to the linked destination content;
the acceptance unit accepts the regeneration request of the second linked destination content when the linked destination content is regenerated; and
the second distribution unit distributes the second linked destination content set to be a regenerating linked destination content when the regeneration request of the second linked destination content is accepted.

6. A content distribution method, comprising:
setting a linked destination content linked to an object content for each object content continuously regenerated according to a preset regeneration sequence; and
accepting a regeneration request of the linked destination content set to be a regenerating object content during a period when the object content is regenerated.
